(19) United States
(12) Patent Application Publication
(10) Pub. No.: US 2011/0051438 A1
(43) Pub. Date: Mar. 3, 2011

(54) SAFE STREETLIGHTS CAPABLE OF SEPARATING LAMP UNIT AND ROTATING ARM

(75) Inventor: Myo in Lee, Daejeon (KR)

(73) Assignee: DASEUNG I & S CO., LTD, Daejeon (KR)

(21) Appl. No.: 12/526,043

(22) PCT Filed: Dec. 11, 2007
(86) PCT No.: PCT/KR2007/006419

§ 371 Date: Nov. 15, 2010

(30) Foreign Application Priority Data
Feb. 5, 2007 (KR) 10-2007-0011334

(51) Int. Cl. F21V 21/26

(52) U.S. Cl. 362/428

(57) ABSTRACT

This invention is the safe street light capable of separating lamp unit and rotating arm designed for preventing the lamp unit from dropping in the lamp unit dropping and rising from the ground for exchanging electric bulb and repairing the lamp unit, and being attached to the pole of the street light firmly, and rotating the arm to work facilitating part, and this invention is installed at the pole of the street light fixedly set up vertically to the ground, and installed on the rotating device turning the arm forming parallel to the ground on the top street light and the above pole of street light, and equipped with the hold attaching device raising and dropping the above lamp unit from the ground, capable of minimizing the safety accident of the operator in repairing and maintenance work, and maximizing operation efficiency.

### TECHNICAL FIELD

This invention is a street light capable of accommodating car and pedestrian moving at night by the radiation of the electric lamp, in detail, related to safe lights capable of separating lamp unit and rotating arm preventing the lamp unit from dropping in the lamp unit dropping by the lamp unit load in dropping and rising from the ground for exchanging electric lamp and repairing the lamp fixed lamp unit, and being attached to the pole of the street light firmly in re-combining, and rotating the arm to work facilitating part. It can be said to be the applied combination of commonly known technology. It is based on mechanical industry as a useful technology to enhance the safety and convenience of working, and efficiency of maintenance by controlling the height and working position of the media of transmitting movement by manpower substituting a motor or a driven motor of internally height-controllable, and the rotating device escaping work on the road, and a street light, and regarded as a parts industry and steel industry.

### BACKGROUND ART

In the past, when the electric bulb of a lamp unit in a street light broke down, they mobilized a ladder car and approached the lamp unit, and substituted it, so they had a lot of trouble exchanging it, and cost a lot of expenses for the maintenance, which brought about a problem in traffic flow, and especially the risk of fall and electric shock accident.

Of late, technologies were developed to improve these problems, but failed in making it practical.

As a technology to control the height of the street light, it bends the support of the street light, by which the worker operates on the ground, and it is rotatable for the support raised rotating stand on the hinge with the rotating stand of one side opened sectional form composed in unity with the support under the support of the electric lamp and connecting stand, the support composed at the plate fixed on the ground, the hinge inserted and combined at the hinge hole of the rotating stand and the support. The street light ascending and descending the electric lamp from the ground was developed by connecting and fixing the flat plate connection string of the flat plat type fixed and connected on the electric lamp unit, being installed inside the street light through a host of rollers, and being connected and fixed on the hold-attaching device in a gear type combination having the stopper and the round type gear part. But the stopper installed in the hold-attaching device does not handle the load of the electric lamp in descending the electric lamp, so drops to the ground, threatening the safety of the operator.

Another method is to make the electric lamp not move, but head for the ground in the electric lamp separating and descending in a lamp appliance separating type detachable from the pole of the street light, and to bond to the pole of the street light with correctness and firmness.

In the device of ascending and descending the lamp for the street light using electric power, not mechanical power, it is located inside the pipe among the connecting part of the pipe and the lamp, and the normally rotating drum by the driving motor, formed around the above drum, and the fixed drum formed in the middle, it moves at a fixed interval focusing on this fixed terminal.

As a method to attach the ascend and descend device to the street light and safely substitute the electric lamp, it is a system to look for direction in the lower body descending from and ascending to the ground, and bond to the upper body, and control the ascending and descending speed with a remote control.

As a rotating method to work on the sidewalk, there is the street light of the lighting-off and on according to the current intermittence at the horizontal material bonded rotatably in the condition that it lies across the upper part of the support as it is formed as a hollowed material for the imbedding of current supply line.

### DISCLOSURE

### Technical Problem

This invention is designed to solve above problems, and purported to provided the safe street light capable of separating lamp unit and rotating arm for preventing the lamp unit from dropping in the lamp unit dropping and rising from the ground for exchanging electric bulb and repairing the lamp unit.

Another purpose is to provide the safe street light capable of separating lamp unit and rotating arm easily raising and dropping the lamp unit using power.

And the third purpose is to provide the safe street light capable of separating lamp unit and rotating arm easy to operate the arm part and move to a safe position.

The fourth purpose is to the safe street light capable of separating lamp unit and rotating arm preventing the flat board connecting string connected to the lamp unit in the arm part rotating from vertically rotating and getting tangled.

The safe street light capable of separating lamp unit and rotating arm of this invention to achieve the above purpose is of type of a lamp unit equipped with the hold-attaching device loosening the flat board connecting string of the flat type and descending the fixed lamp unit to the above pole of the flat board connection, hold-attaching the above flat-board connecting string and combining the above lamp unit to the street light in the lamp unit of the electric lamp installed in the street light as necessary, which is featured by the rotating device installed at the pole of the street light fixedly set up vertically to the ground, rotating the arm part parallel to the ground on the top of the above pole of the street light, the 1st worm gear part rotated and driven with the insertion hole of polygonal shape at one end, and the 1st worm wheel part combined with the above 1st worm gear part in a mutually gear type, and rotated vertically, and equipped with the penetration hole.

Also it is characterized by the wire fixedly connected to the penetration hole of the above hold-attaching device, and connected and fixed to the above flat board connection string with the idle rotation part of bearing subsidiary material involved.

Also the above rotating device is characterized by the 2nd worm gear part formed of polygonal insertion hole and rotated at one end, the 2nd worm wheel part mutually gear-type combined with the 2nd worm gear part and vertically rotated, and the round gear mutually gear-type combined with the above 2nd worm gear part and vertically rotated and fixed at the above arm part.

Also it is characterized by the bearing part installed and fixed at the above street light, accepting and rotating and supporting the above round shaft.

### Technical Solution

The fourth purpose is to the safe street light capable of separating lamp unit and rotating arm preventing the flat board connecting string connected to the lamp unit in the arm part rotating from vertically rotating and getting tangled.

The safe street light capable of separating lamp unit and rotating arm of this invention to achieve the above purpose is of type of a lamp unit equipped with the hold-attaching device loosening the flat board connecting string of the flat type and descending the fixed lamp unit to the above pole of the flat board connection, hold-attaching the above flat-board connecting string and combining the above lamp unit to the street light in the lamp unit of the electric lamp installed in the street light as necessary, which is featured by the rotating device installed at the pole of the street light fixedly set up vertically to the ground, rotating the arm part parallel to the ground on the top of the above pole of the street light, the 1st worm gear part rotated and driven with the insertion hole of polygonal shape at one end, and the 1st worm wheel part combined with the above 1st worm gear part in a mutually gear type, and rotated vertically, and equipped with the penetration hole.

Also it is characterized by the wire fixedly connected to the penetration hole of the above hold-attaching device, and connected and fixed to the above flat board connection string with the idle rotation part of bearing subsidiary material involved.

Also the above rotating device is characterized by the 2nd worm gear part formed of polygonal insertion hole and rotated at one end, the 2nd worm wheel part mutually gear-type combined with the 2nd worm gear part and vertically rotated, and the round gear mutually gear-type combined with the above 2nd worm gear part and vertically rotated and fixed at the above arm part.

Also it is characterized by the bearing part installed and fixed at the above street light

accepting and rotating and supporting the above round shaft.

### ADVANTAGEOUS EFFECTS

As seen above, the safe street light capable of separating lamp unit and rotating arm rotates the arm part using the hold-attaching device and the rotating device, and it is structured of capable of descending and ascending the lamp unit, so able to minimize the occurrence rate of safety accident of operators, and maximize their working efficiency.

Especially, this invention has an effect of preventing the descend of the lamp unit and the rotation of the arm part using the worm gear independent of the operator's will

### BEST MODE

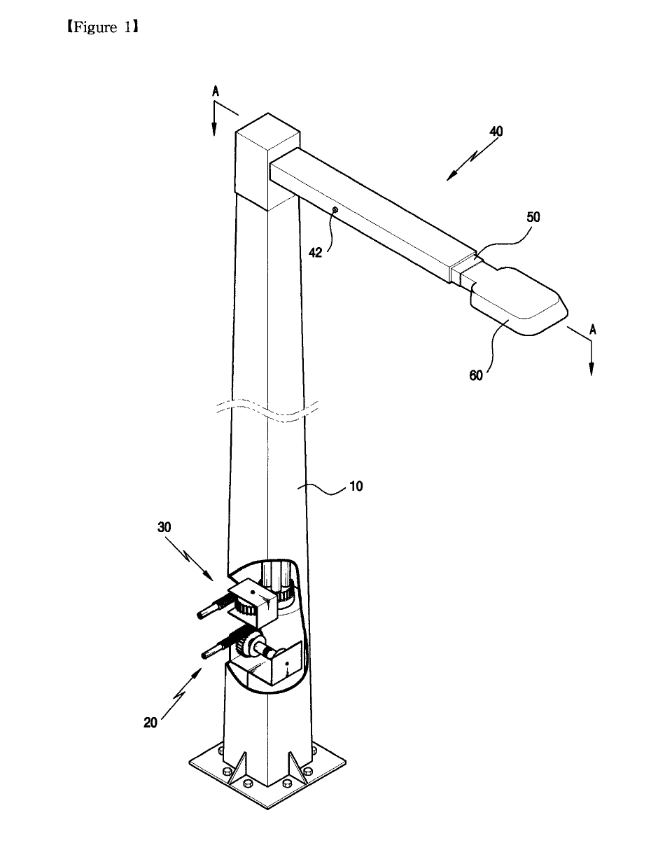

FIG. 1 is the squint view indicating this invention.

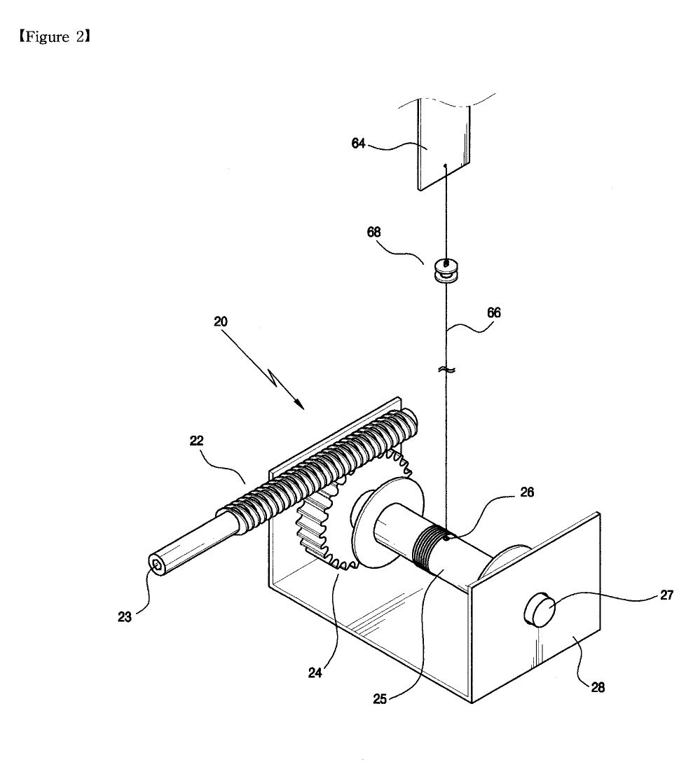

FIG. 2 is the squint view indicating the hold-attaching device view in this invention.

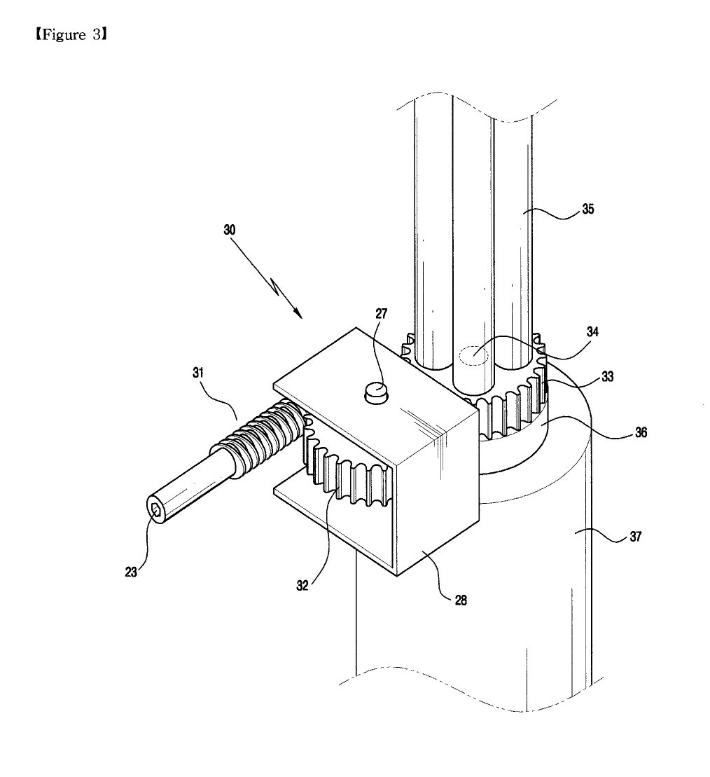

FIG. 3 is the squint view indicating the rotating device view in this invention.

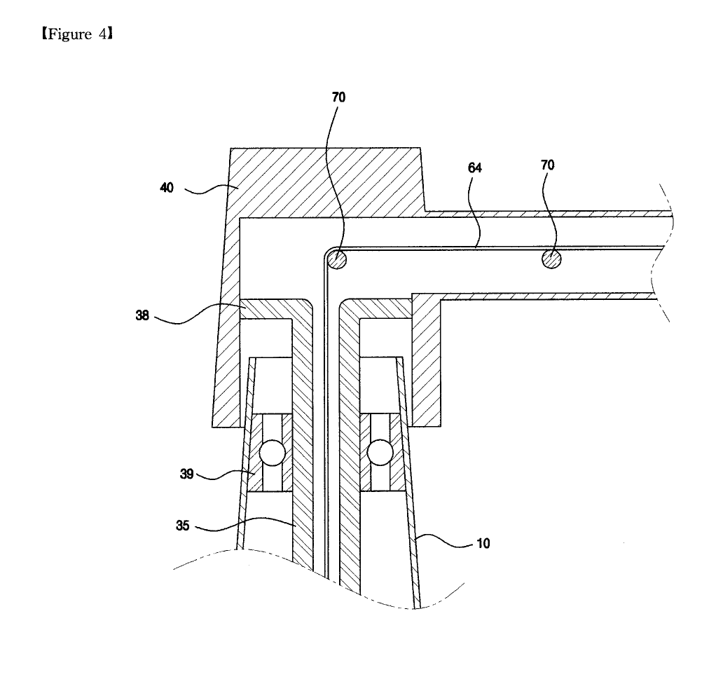

FIG. 4 is the ‘A-A’ part section view in this invention.

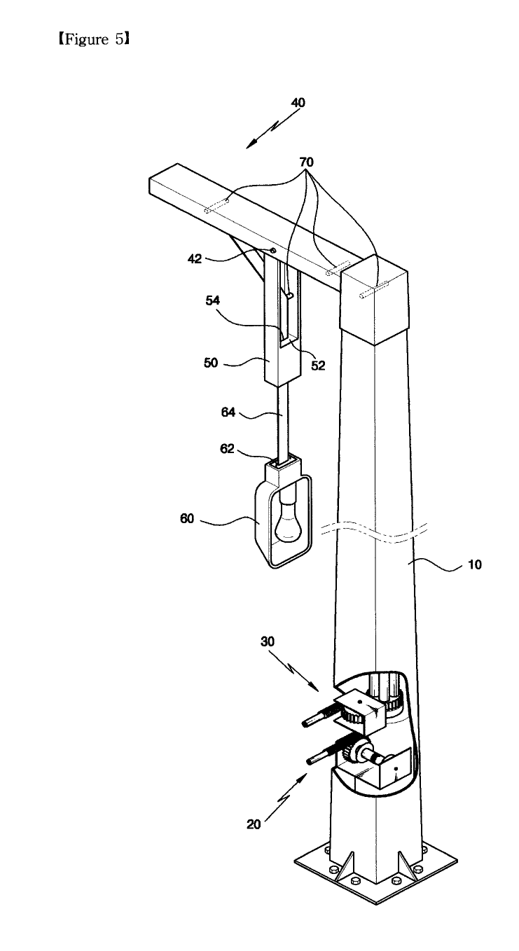

FIG. 5 is the squint view indicating the operating condition in this invention.

### DESCRIPTION OF SYMBOLS OF MAIN PARTS OF DRAWING

| | |
|---|---|
| 10: Pole of Street Light | 12: Opening Hole |
| 20: Hold-attaching Device | 22: 1st Worm Gear |
| 23: Insertion Groove | 24: 1st Worm Wheel |
| 25: Hold-attaching Part | 26: Penetration Hole |
| 27: Worm Shaft | 28: Housing |
| 30: Rotating Device | 31: 2nd Worm Gear |
| 32: 2nd Worm Wheel Part | 33: Round Gear |
| 34: Information Hole | 35: Round Shaft |
| 36: Turn Table | 37: Flange |
| 38: Cut-bend Part | 39: Bearing Part |
| 40: Arm Part | 42: Rotating Shaft |
| 50: Rotating Arm | 52: Guide Means |
| 54: Guide Groove | 60: Lamp Unit |
| 62: Electricity Plug | 64: Flat Board Connect String |
| 66: Wire | 68: Idle Rotating Part |
| 70: Guide Roller | |

### MODE FOR INVENTION

The operation example of this invention hereunder is explained in detail as follows.

FIG. 1 is the squint view indicating the safe street light capable of separating lamp unit and rotating arm.

The above street light is composed of the pole of street light (10) fixedly installed vertically to the ground, the arm part (60) rotationally installed at the top of the above pole of street light (10), including the rotating arm (50), and the lamp unit (60).

The above rotating arm (50) stands to the ground focusing on the rotating shaft (42) installed at the above arm part (40), or parallel to the ground as accepted in the above arm part (40), so is capable of being separated from or combined with the above lamp unit (60).

Also under the pole of street light (10), the hold-attaching device (20) and the rotating device (30) is installed and composed described later.

Here, the detailed composition of the hold-attaching device (20) and the rotating device (30) is as FIGS. 2, 3.

FIG. 2 is the squint view of the hold-attaching device (20) of this invention.

As illustrated at FIG. 2, the above hold-attaching device (20) is composed of the housing (28), the 1st worm gear part and the 1st worm wheel part (24).

The above housing (28) has a form of “t” letter formed in left, right, both sides and lower side, and installed and fixed inside the pole of street light (10).

The above 1st worm wheel part (24) is equipped with the penetration hole (26) in the center, composed if the hold-attaching part (25) and the round gear intervening the wire (66) connected and fixed at the above penetration hole (26), rotationally connected with the both ends of the worm shaft (27) inserted to the both sides of the above housing (28).

The above 1st worm gear part (22) is combined in a mutual gear-type with the above 1st worm wheel part, vertically rotated, and formed with the insertion groove (23) of polygonal shape at one end.

Also to the insertion groove (23) of the above 1st worm gear part (22), a manually operable handle is combinable, but the combination of a motor built-in tool is desirable.

Also the above wire (66) is connected and fixed to the flat board connection string (64) through the idle rotating part (68) with of top subsidiary material and bottom subsidiary material of bearing subsidiary material idly rotated respectively.

Also the above wire (66) is formed longer and higher than the ground and the above lamp unit (60).

That is, when the above worm gear part (22) rotates according to the above structure, it is combined with the above 1st worm gear part (22) in a mutual gear type, so the worm wheel part (24) equipped with the hold-attaching part (25) is vertically rotated as well.

At this point, the wire (66) connected and fixed at the penetration hole (26) of the hold-attaching part (25), connected and fixed through the above flat board connection string (64) and the idle rotating part (68), is held and attached to the hold-attaching part (25) vertically rotated by the rotation of the above 1st worm gear part.

FIG. 3 is the squint view of the rotating device (30) of this invention.

As illustrated at FIG. 3, the above rotating device (30) is composed of the housing (28), the 2nd worm gear part (31), the 2nd worm wheel part (32) and the round gear (33).

The above housing (28) has “t” letter formed to up, down, both sides and right side, and fixed and installed inside the pole of street light (10).

The above worm wheel part (32) is inserted to the both sides of the worm shaft (27) on both sides of the above housing (28), and rotationally connected.

The above 2nd worm gear part (31) is formed of the polygonal insertion groove (23) at one end, and combined with the above 2nd worm wheel part (32) on the other end and vertically rotated.

The above round gear (33) is combined in a mutual gear type with the other end of the above 2nd worm wheel part (32), vertically rotated, and formed of many round shafts (35) with the cut and bend part (38) equipped with the information hole (34) at the center, and levelled with the ground centering on the above information hole (34) alongside the circumferential side.

Also it is equipped with the turn table (36) smoothly facilitating the rotation of the round gear (33) equipped with the above round shaft (35), and formed of the flange (37) supporting the above turntable (36).

At this point, the wire (60) of the hold-attaching device (20) and the flat board connection string (64) installed lower than the above rotating device (30) is accepted and formed to the information hole (34) of the round gear (33) stably settled, fixedly installed at the turntable (36) and the above turntable through inside the above flange (37).

Also to the insertion groove (23) of the above 2nd worm gear part (31), a manually operable handle is combinable, but the combination of a motor built-in tool is desirable.

That is, when the above 2nd worm gear part (31) rotates according to the above structure, the 2nd worm wheel part (32) combined with the above 2nd worm gear part (31) in a mutual gear type is vertically rotated as well.

At this point, the round gear (33) equipped with a host of the round shafts (33) combined with the above 2nd worm wheel part (32) in a gear type is vertically rotated and the above arm part (40) fixedly connected the cut and bend part (38) of the above round shaft (35) is vertically rotated as well.

FIG. 4 of the section view of “A-A” part of this invention.

Inside the pole of street light (10) accepted to the arm part (40) parallel to the ground, the bearing part (39) is fixedly installed, and the round shaft (35) is formed fixed using welding as closely accepted to the above bearing part (39), with the cut and bend part (38) contacting one side of the arm part (40).

Also it is formed through a host of guide rollers (70) with the flat board connection string (64) installed at the arm part (40) along the information hole (33) equipped with the above round shaft (35).

Also, the lowest bottom part of the above arm part (40) is formed at a interval with the above pole of street light (10).

That is, according to the above structure, the cut and bend part (38) of many round shafts (35) formed as one body to the round gear (33) of the above rotating device (30) is fixed the above arm part (40) through the bearing part (39), and the above arm part (40) is rotated by the above rotating device (30) driven by the motor tool.

At this point, the above bearing part (39) more closely supports and rotates the round shaft (35), so facilitates the rotation of the round shaft (35).

FIG. 5 is the squint view indicating the operation condition of this invention.

The above rotating arm (50) rotated on the rotating shaft (42) of the above arm part (40), is composed o the guide groove (54) equipped guide means (52), and the roller (70), which is connected to the above lamp unit (60) through the flat board connection string (64).

The end of the above flat board connection string (64) is connected and fixed at the wire (66) through a host of guide rollers (70) connected and fixed at on end of the lamp unit (60), and internally installed at the above arm part (40) the pole of street light (10) through the guide groove (54) and the roller (70) of the above rotating arm (50).

Also at the guide means (52) of the rotating arm (50), an un-illustrated plug hole is formed that the electric connection plug (62) protruded and formed at one side of the lamp unit (60) is inserted, by which to be connected to the un-illustrated connection terminal inside.

Like this, for the safe street light capable of separating lamp unit and rotating arm, the operator, the operator in changing the electric lamp or repairing the electric lamp fixed lamp unit, operates the switch by inserting the motor tool the 2nd worm gear (30) of the above rotating device (30), and rotates the arm part (4) to a better working place.

That is, if power is transmitted to the rotating direction with the motor tool inserted to the insertion groove (23) of the 2nd worm gear part (31), the 2nd worm wheel part (32) combined with the one side of the above 2nd worm gear part (31) in a gear type is vertically rotated as well.

The round gear (33) combined with the 2nd worm wheel part (31) in a gear type and vertically rotated, and equipped with a host of round shafts (35) is vertically rotated, and the arm part (40) fixed with the above round shaft (35) is vertically rotated as well.

At this point, the above round shaft (35) is more smoothly rotated using the flange (37) supporting the turntable (36) and the above turntable (36), and the above round shaft (35) more closely rotates the above arm part (40) using the bearing part (39) fixed and installed on the top.

In rotating the above arm part to a better working place, and dropping the lamp unit, the operator repairs and maintains by inserting the motor tool to the 1st worm groove (22) of the above hold-attaching device (20), and operating the switch to turn the above 1st worm gear part (22), and descending the lamp unit (60) connected and fixed on the above flat board connection string (64).

In combining the lamp unit to the arm part after repairing and maintaining, the operator inserts the motor tool (hand drill) to the insertion groove (22) of the 1st worm gear (22) in the above hold-attaching device (2), turns on the switch to rotate the above 1st worm gear part (22) in a reverse direction to the hold-attaching, and raises the above lamp unit from the ground and combines it to the arm part.

That is, when power is transmitted to the hold-attaching direction with the motor tool inserted to the insertion groove (23) of the above 1st worm gear part (22), the wire (66) is held and attached to the penetration hole (26) of the 1st worm wheel part (24) combined with the above 1st worm-gear part (22) in a gear type, vertically rotated.

At this point, the above wire (66) is connected through the flat board connection string (64) and the idle rotating part (68) connected and fixed to the lamp unit (60), so the above lamp unit (60) is raised from the ground.

The safe street light capable of separating lamp unit and rotating arm such as the above structure, has an effect of rotating vehicles and pedestrians from the arm part (40), and sharply reducing the occurrence rate of safety accident of operators.

### INDUSTRIAL APPLICABILITY

Main demanders of the street light are composed of all classes of local governments, public offices, reformed new towns of local governments, construction companies. The factors influencing growth include civil petition to the damage of electric lamp, electric shock accident by electric leak, increased maintenance expenses of the street light, and energy saving, of which the frequent occurrence of civil petitions due to electric shock accident and damage by electric leak can be the most important influence in the growth of a new market. The safe street light capable of separating lamp unit and rotating arm

is capable of selecting the safe position of the worker, preventing a fall accident, saving maintenance expenses greatly, working by one man, handling rapid civil petitions with viable showing the increase of workload and without traffic jam, and getting over the limits of park, mountain, and locality. It is purported to help each local government save the maintenance expenses of the street light greatly and make up for difficult local finance.

1. The safe street light capable of separating lamp unit equipped with the hold-attaching device which loosens the flat board connection string (64), descends the lamp unit (60) fixed on the above flat board connection string (64) to the ground, holds and attaches the above flat board connection string (64), and combines the above lamp unit (60) to the street light,
it is characterized by equipping with the rotating device (30) installed at the pole of street light (10) installed fixed and installed on the ground in a vertical direction, the rotating device (30) rotating the arm part (40) formed parallel to the ground on the top of the above pole of street light (10), the hold-attaching device (20) composed of the 1st worm wheel part (24) including the hold-attaching part (25) combined with the 1st worm gear part (22) rotated and driven by the formation of polygonal insertion (23), and the above 1st worm gear part (22) in a gear type, vertically rotated, and having the penetration hole (26).

2. In the 1st paragraph 1,
the safe street light capable of separating lamp unit and rotating arm is characterized by equipping with the wire (66) connected and fixed at the penetration hole (20) of the above hold-attaching device (20), interrelated with the idle rotating part (68) of bearing subsidiary materials, and connected and fixed to the above flat board connection string (64).

3. In the paragraph 1,
the safe street light capable of separating lamp unit and rotating arm is characterized by equipping with the above rotating device (30) composed of the 2nd worm gear part (31) rotated by the formation of polygonal insertion hole (23) at one end, the 2nd worm wheel part (32) combined with the above 2nd worm gear part (31) in a gear type, vertically rotated, and the round gear (33) combined with the above 2nd worm gear part (32) in a gear type, vertically rotated, and formed of a host of round shafts (35) fixed at the above arm part, and the turntable (36) fixed and installed at the above round gear (33), and the flange (37) supporting the above turntable (36) and the round gear (33).

4. In the paragraph 3,
the safe street light capable of separating lamp unit and rotating arm is characterized by equipping with the bearing part (39) installed and fixed at the above pole of street light and accepting, rotating and supporting the above round shaft (35).
